(19) United States
(12) Patent Application Publication
(10) Pub. No.: US 2024/0143476 A1
(43) Pub. Date: May 2, 2024

(54) Method and Apparatus for Ascertaining a Health Characteristic Variable of a Machine

(71) Applicant: Siemens Aktiengesellschaft, Muenchen (DE)

(72) Inventors: Philipp AGETHEN, Erlangen (DE); Supradeep CHIKABALLAPUR-MANJUNATH, Nürnberg (DE); Timo MÜHLHAUSEN, Nürnberg (DE); Ke ZHANG, Mannheim (DE); Tobias LUCKNER, Rosstal (DE); Maik BOCHE, Oberasbach (DE); Wolfgang BÖLDERL-ERMEL, Wendelstein (DE); Ronald Dan MAGBALOT, Erlangen (DE)

(21) Appl. No.: 18/384,205

(22) Filed: Oct. 26, 2023

(30) Foreign Application Priority Data
Oct. 27, 2022 (EP) 22204125

(51) Int. Cl. G06F 11/34; G06Q 40/08

(52) U.S. Cl. CPC G06F 11/3447; G06Q 40/08

(57) ABSTRACT

Method and apparatus for ascertaining a at a current time of consideration and for future times of consideration, wherein a first time profile of a base characteristic variable is mapped over the operating time, where the first time profile of the base characteristic variable represents a state of a reference machine at the time of consideration in dependence on the operating time and an actual characteristic variable that varies over the operating time be calculated by means of an individual function, where an input variable fed to the individual function is a performance characteristic variable of the machine, which is detected periodically via a machine data detection unit or is predicted for future operating times, and where the health characteristic variable is displayed as a second time profile by adding the ascertained actual characteristic variable or the predicted actual characteristic variable to the first time profile.

### BACKGROUND OF THE INVENTION

### 1. Field of the Invention

The invention relates to a method for ascertaining a health characteristic variable of a machine at a current time of consideration and future times of consideration, where the health characteristic variable represents a state of the machine at the time of consideration in dependence on an operating time for which purpose a base function is used that maps a first time profile of a base characteristic variable over the operating time, where the first time profile of the base characteristic variable represents a state of a reference machine at the time of consideration in dependence on the operating time and is ascertained either from historical observations of a group consisting of a plurality of machines of the same type or from knowledge-based expectations based on at least three successive data points, and where the base characteristic variable represents a state of the reference machine at the time of consideration in dependence on an operating time.

### 2. Description of the Related Art

At present, the machine operators, machine manufacturers and in particular machine insurers involved do not know the current state and the deterioration of a machine. Without this knowledge about the actual state or future deterioration, issues such as insurance risk, expected lifetime and residual value are unknown factors which can only be estimated once at the time of conclusion of a contract.

Accordingly, it is unclear to the parties involved whether the negotiated terms of the insurance contract still correspond to reality once the machine has started production. It would also be possible to provide dynamic insurance scenarios for the insurance companies in which the rates can be adjusted according to the running time.

### SUMMARY OF THE INVENTION

In view of the foregoing it is an object of the invention to provide a real-time evaluation of the state or predicted deterioration of a machine in the form of a health index or a health characteristic variable to enable machinery insurers to adjust contract terms and in particular insurance rates.

This and other objects and advantages are achieved in accordance with the invention by a method mentioned in which an actual characteristic variable that varies over the operating time is calculated via an individual function, where an input variable fed to the individual function is a performance characteristic variable of the machine that is detected periodically via a machine data detection unit or is predicted for future operating times, and where the health characteristic variable is displayed as a second time profile by adding the ascertained actual characteristic variable or the predicted actual characteristic variable to the first time profile.

The inventors have recognized that, in order to determine the health characteristic variable, it is necessary to consider a different type of data, namely, for example, the performance variables of a machine. In this regard, it should be noted that machine data is all information that accumulates on a machine and is at present already collected via machine data detection units or made available in a cloud environment. Herein, a basic distinction is made between two types of data, namely product data and process data. Process data is information that is required for the operation of a machine and information generated directly by the operation of a machine. Process data primarily comprises control data and consumption data and assists process monitoring. Product data is information created during production. This data is measured in processing units and provides information on the production process and the quality of production. If a performance characteristic variable of a machine, for example a manufactured quantity, is now ascertained, then this is not necessarily data such as that obtained at present in systems in a fine-grained manner, but rather higher-level data, i.e., technical data that is not specific to a machine. In conventional systems, machine-specific technical data relating in a fine-grained manner to subcomponents, such as speed, temperature, torque, is detected. This fine-grained data cannot be used for insurance-related scenarios.

Advantageously, for historical observations for the base characteristic variable, a quantity of manufactured units per time unit of the reference machine is defined as an observation parameter, where a quantity of manufactured units per time unit of the machine is also selected for the periodically detected performance characteristic variable, where a deviation between the quantity of the reference machine and the quantity of the machine is provided as a factor and is used in the individual function as a correction factor for the calculation of the actual characteristic variable, whereby ultimately a result of the health characteristic variable is optimized and thus the second time profile is influenced such that it is more informative.

Therefore, it could be said that, the more a machine produces, the more the health index shifts to a lower limit and, in contrast, if nothing at all is produced, the index shifts to an upper limit.

Such real-time monitoring enables the health index or the health characteristic variable of a machine to be displayed realistically. Insurers and machine operators can now obtain feedback as to whether the insured machine is still the contractually agreed item, in particular whether the insured machine is still within a permissible risk corridor.

Infrastructure data, in particular geoinformation data, can be used as further non-machine-specific data. For this purpose, an installation site of the machine is fed to the individual function as a further input variable with which environmental factors are ascertained that describe the environmental influences on the machine at the installation site of the machine, where at least one environmental factor is used in the individual function as at least one further correction factor for the calculation of the actual characteristic variable which influences the health characteristic variable and thus the second time profile.

Infrastructure data subsumes all facility-related data of a physical or institutional nature with a specific spatial reference. This data can be used to describe supply situations and network structures and to identify correlation patterns via a geoinformation system. For example, a prevailing climate at an installation site can be used to predict the totality of all metrological phenomena within a lengthier period for the specific region of the installation site. Hence, specific factors for “weather conditions” are known. Accordingly, it is possible to take into account solar radiation, heavy rain load, water vapor content of the air, wind, air pressure, dust load and CO2 load for the lifetime of the machine.

Providing the health characteristic variable is furthermore improved if a further input variable fed to the individual function is a period between two successive maintenance operations, i.e., the basic maintenance interval and a remaining residual time to the next maintenance interval, where the remaining residual time is used in the individual function as a further correction factor for the calculation of the actual characteristic variable that influences the health characteristic variable and thus the second time profile.

Maintenance serves to delay the existing potential for wear. The performance of maintenance substantially means minimizing the actual wear of parts, assemblies and subcomponents. This maintenance event, and thus the extension of the lifetime, is taken into account for the calculation of individual functions.

The determination of the health characteristic variable can be furthermore improved if the machine is divided into subcomponents and a degradation profile is provided for each subcomponent, where the degradation profiles of the subcomponents are used in the individual function for the calculation of the actual characteristic variable. When a subcomponent is replaced by a replacement part, the associated degradation profile is shifted in time for the calculation in the individual function and thus the health characteristic variable is positively influenced.

Since repair means all measures for restoring the unit under consideration to a functional state, i.e., the parts of the subcomponents are replaced one-to-one and hence are once again as good as new, this new state of a subcomponent is taken into account in the calculation of the health characteristic variable.

In accordance with the method, the aforementioned risk corridor can be illustrated if, in a screen view for a health estimation of the machine, in addition to the first time profile and the second time profile, a third time profile and a fourth time profile are displayed, where the third time profile is a lower limit for a permissible range of the health characteristic variable and the fourth time profile is an upper limit for a permissible range of the health characteristic variable, where a three-stage evaluation is performed for the health estimation of the machine, and, in the event of the health characteristic variable having a value above the first time profile, a first state is assigned to a state value, in the event of the health characteristic variable having a value below the first time profile but still above the third time profile, a second state is assigned to the state value and, in the event of the health characteristic variable having a value below the third time profile, a third state is assigned to the state value.

In practice, a 10% or a 90% share from the historical data have each proven useful for the lower and the upper limit when ascertaining the base index. The three-stage evaluation can advantageously be depicted in a traffic light display that hence shows green for good (first state), yellow for sufficient (second state) and red for deficient (third state).

It is now advantageous not to have a plurality of items of technical data, for example, from a spindle, from a drive or from temperature and motion sensors, but to use an easily understandable simple KPI (key performance index) for insurance-related scenarios, such as the aforementioned traffic light with the colors red, yellow and green.

Accordingly, advantageously, the method can be used for plant calculations for machine insurance and for ascertaining insurance rates for the machine, where the actual state and the deterioration of the machine is visually displayed to a machine operator and an insurer and thus an insurance risk can be determined, in particular insurance rates can be dynamically adjusted. In short, it is now clear to all parties involved whether the negotiated terms of the insurance contract correspond to reality.

Providing or ascertaining the base function can be considered to be a significant advantage for the calculation of the health characteristic variable. The base function or a base estimator is not specific to a particular type of machine, but rather depends on operating time and typical machine usage. For this purpose, it has been found to be advantageous to use a generalized exponential time-varying equation that reflects either historical observations or knowledge-based expectations.

For this purpose, an exponential function is used in the base function, in particular the following relationship:

h(t)=1−d−exp(at^{b}),

and a function with the following subfunctions is used in the individual function Actual characteristic variable (hi)=A*K1+B*K2+C*K3+D*Σf(t), subcomponents (S1,S2,S3,S4).

The object and advantages in accordance with the invention are also achieved by a computer system, where the computer system is configured to ascertain an overall characteristic variable of a machine at a current time of consideration and for future times of consideration, and where the health characteristic variable represents a state of the machine at the time of consideration in dependence on an operating time, comprising a health model with a base estimator, which is configured to use a base function to map a first time profile of a base characteristic variable over the operating time on a screen view, where the first time profile of the base characteristic variable represents a state of a reference machine at the time of consideration in dependence on the operating time and is ascertained either from a database and historical observations of group consisting of a plurality of machines of the same type or from a knowledge database with knowledge-based expectations based on at least three successive data points, and where the base characteristic variable represents a state of the reference machine at the time of consideration in dependence on an operating time.

The health model furthermore has a machine estimator configured to calculate an actual characteristic variable that varies over the operating time via an individual function, where an input variable fed to the individual function is a performance characteristic variable of the machine, which is periodically detected via a machine data detection unit and can be retrieved in a memory for performance variables or can be predicted for future operating times via a predictor.

Also provided is a calculation unit (calculator or processor) configured to provide a second time profile as a health characteristic variable by adding the ascertained actual characteristic variable or the predicted actual characteristic variable to the first time profile.

In a further embodiment of the computer system, the database for the historical observations for the base characteristic variable contains a quantity of manufactured units per time unit of the reference machine as an observation parameter, where the performance variable data for the periodically detected performance characteristic variable furthermore likewise contains a quantity of manufactured units per time unit of the machine, and where the individual function is configured to use a deviation between the quantity of the reference machine and the quantity of the machine as a correction factor in the calculation of the actual characteristic variable, whereby ultimately a result of the health characteristic variable is optimized and thus the second time profile is influenced such that it is more informative.

Furthermore, the individual function in the computer system is configured such that infrastructure data is requested via the machine data detection unit. This infrastructure data is provided to the individual function as a further input variable. Accordingly, the individual function is configured to evaluate an installation site of the machine and is furthermore configured to ascertain therefrom environmental factors describing the environmental influences on the machine at the installation site of the machine, where the individual function is configured to use at least one environmental factor as at least one further correction factor for the calculation of the actual characteristic variable.

In the computer system, the individual function is furthermore configured to evaluate as a further input variable a period between two successive maintenance operations, i.e., the basic maintenance interval, and a remaining residual time to the next maintenance, where the individual function is configured to use the remaining residual time as a further correction factor for the calculation of the actual characteristic variable.

The shorter the residual time, the lower the subsequent health index or health characteristic variable. The computer system improves its prediction quality because the individual function is configured to evaluate degradation profiles of subcomponents of the machine. For this purpose, a subcomponent library is provided, where the degradation profiles are allocated to the subcomponents of the machine, where the individual function is configured to use the degradation profiles of the subcomponents for the calculation of the actual characteristic variable and, as time progresses, to reduce the actual characteristic variable, and where the health model is configured, when a subcomponent has been replaced by a replacement part, to shift the associated degradation profiles for this replaced subcomponent in time for the calculation in the individual function and thus positively influence the health characteristic variable.

Furthermore, the computer system is configured, in addition to the first time profile and the second time profile, to display a third time profile and a fourth time profile in the screen view for the health estimation of the machine, where the third time profile is formed as a lower limit for a permissible range of the health characteristic variable and the fourth time profile is formed as an upper limit for a permissible range of the health characteristic variable, where an estimator configured to perform a three-stage evaluation is provided for the health estimation of the machine and 1., in the event of the health characteristic variable having a value above the time profile, a first state is assigned to a state value, 2., in the event of the health characteristic variable having a value below the time profile but still above the third time profile, a second state is assigned to the state value and, 3. in the event of the health characteristic variable having a value below the third time profile, a third state is assigned to the state value.

This now provides a graphical illustration in the style of a traffic light, for example, green, yellow and red. The risk in the risk corridor spanned by the upper limit and the lower limit can now be easily displayed using the colors.

The computer system is configured for online calculation of machine insurance and for ascertaining insurance rates, where the actual state and the deterioration of the machine can be visually displayed to a machine operator and an insurer on the screen view and thus an insurance risk can be determined bilaterally, in particular configured to dynamically adjust the insurance rates.

It is now advantageously clear to all parties involved at the time of conclusion of the contract whether the negotiated terms are realistic or still valid.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 shows a computer system connected via a machine data detection unit on a machine in accordance with the invention;

FIG. 2 shows a screen view for displaying a health characteristic variable in accordance with the invention;

FIG. 3 shows a dependence of an impact on the health characteristic variable related to a quantity of a reference machine to be manufactured in accordance with the invention;

FIG. 4 shows impacts of maintenance intervals on the health characteristic variable of FIG. 2,

FIG. 5 shows impacts of subcomponents on the health characteristic variable of FIG. 2;

FIG. 6 shows contractors concluding machinery insurance; and

FIG. 7 is a flowchart of the method in accordance with the invention.

### DETAILED DESCRIPTION OF THE EXEMPLARY EMBODIMENTS

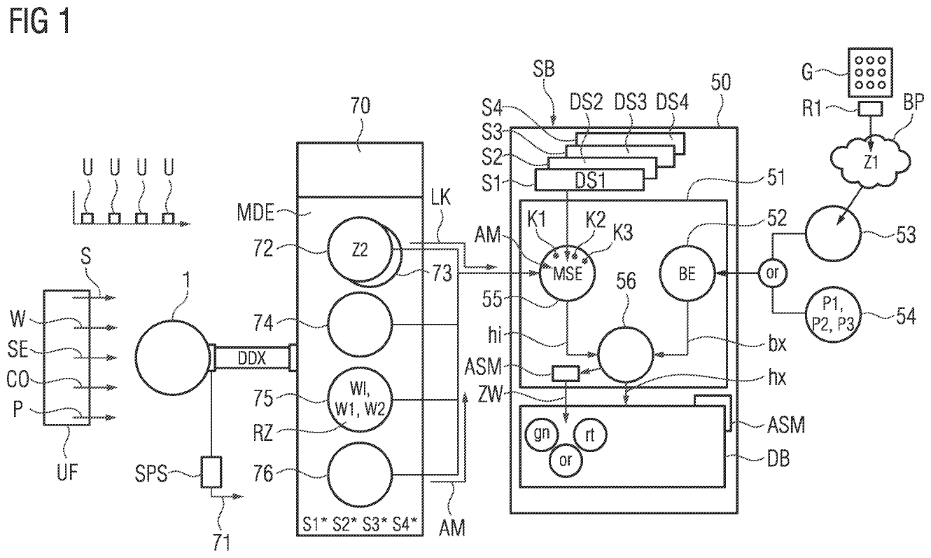

FIG. 1 depicts a machine 1, which manufactures units U. The machine 1 is controlled via a programmable logic controller (PLC). The machine 1 and the PLC are connected to a machine data detection unit MDE via a data channel DDX. The PLC supplies process data 71, which particularly includes temperatures, speeds, pressures, vibrations, noises, i.e., fine-grained machine-specified technical data. However, product data 70 comprising performance variables MLK, such as quantities, are also detected. Depending upon the installation site 74 of the machine 1, environmental factors UF act on the machine 1. In this example, possible environmental factors UF are solar radiation S, water vapor content W, dust load St, CO₂ load CO and air pressure P.

The computer system 50 is configured to ascertain a health characteristic variable hx of the machine 1 at a current time of consideration t and for future times of consideration t′, where the health characteristic variable hx represents a state of the machine 1 at the times of consideration t in dependence on an operating time OT.

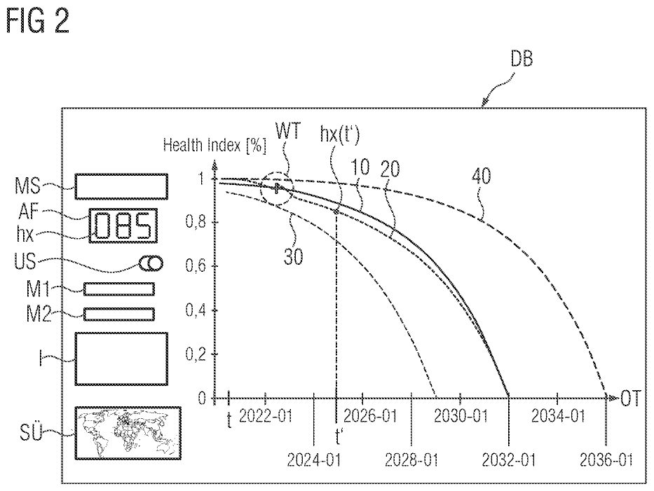

The computer system 50 has a health model 51, which in turn has a base estimator 52, a machine estimator 55 and a calculation unit 56. The base estimator 52 is configured to use a base function BE to map a first time profile 10 (see FIG. 2) of a base characteristic variable bx over the operating time OT on a screen view DB, and the first time profile 10 of the base characteristic variable bx represents a state of a reference machine R1 at the time of consideration t in dependence on the operating time OT. The base function BE is ascertained either from a database 53 with historical observations of a group G consisting of a plurality of machines of the same type or from a knowledge database 54 with knowledge-based expectations based on at least three successive data points P1,P2,P3. For a subsequent quantity-based consideration, at least one first quantity Z1 is introduced as an observation parameter BP. The base characteristic variable bx represents a state of the reference machine R1 at the times of consideration tin dependence on an operating time OT.

Accordingly, the health model 51 interacts with the machine estimator 55 and the base estimator 52 such that the health characteristic variable hx is provided via the calculation unit 56. Herein, the machine estimator 55 is configured to calculate an actual characteristic variable hi that varies over the operating time via an individual function MSE, where an input variable fed to the individual function MSE is a performance characteristic variable LK of the machine 1. The performance characteristic variable LK is detected periodically via the machine data detection unit MDE and stored ready for retrieval in a memory for performance variable data 72 or the performance characteristic variable LK is predicted for future operating times t′ via a predictor 73.

The calculation unit 56 is now configured to provide a second time profile 20 (see FIG. 2) as a health characteristic variable hx by adding the ascertained actual characteristic variable hi or the predicted actual characteristic variable hi to the first time profile 10.

The time profiles 10,20 are displayed in a screen view DB (dashboard). The machine data detection unit MDE supplies a second quantity Z2 for the amount of manufactured units U per time unit. The database 53 for the historical observations for the base characteristic variable bx is likewise used to store a quantity, i.e., a first quantity Z1 of manufactured units U per time unit of the reference machine R1 as an observation parameter. The individual function MSE is now configured to use a deviation between the quantity Z1 of the reference machine R1 and the quantity Z2 of the machine 1 as a correction factor K1 in the calculation of the actual characteristic variable. This calculation ultimately optimizes a result of the health characteristic variable hx and thus the second time profile 20 is influenced such that it is more informative.

The machine data detection unit MDE furthermore detects and stores infrastructure data that is made available to the individual function MSE as further input variables, for example, an installation site 74 of the machine 1. The individual function MSE is now configured to ascertain environmental factors UF at the installation site 74, where the environmental factors UF describe the environmental influences on the machine 1 at the installation site 74 of the machine 1. The individual function MSE is now configured, to use at least one environmental factor UF as at least one further correction factor K2 for the calculation of the actual characteristic variable hi. If the climatic conditions at the installation site 74 mean, for example, that the water vapor content W is extremely high, then this has a negative effect on the health index hx to be calculated in the individual function MSE.

The individual function MSE is also configured to evaluate a period between two successive maintenance operations W1,W2, i.e., the basic maintenance interval WI, and a remaining residual time RZ to the next maintenance W2 as a further input variable. Herein, the individual function MSE is configured to use the remaining residual time RZ as a further correction factor K3 for the calculation of the actual characteristic variable hi.

For the calculation of the health characteristic variable hx of the machine 1, the individual function MSE is further optimized if the individual function MSE is configured to evaluate degradation profiles DS1,DS2,DS3,DS4 of subcomponents S1,S2,S3,S4 of the machine 1. Accordingly, a subcomponent library SB is provided, which describes a first subcomponent S1, a second subcomponent S2, a third subcomponent S3 and a fourth subcomponent S4. The first subcomponent S1 could, for example, be a motor, the second subcomponent S2 could, for example, be an arrangement of rotor blades of a compression machine, the third subcomponent S3 could be a protective shield and the fourth subcomponent S4 could be an electronic module.

The subcomponents S1, . . . , S4 are accordingly allocated their degradation profiles DS1, . . . , DS4, where the individual function MSE is configured to use the degradation profiles DS1, . . . , DS4 of the subcomponents S1, . . . , 54 for the calculation of the actual characteristic variable hi and, as time progresses, to reduce the actual characteristic variable hi. Herein, the health model 51 is configured, when a subcomponent S1, . . . , 54 has been replaced by a replacement part, to shift the associated degradation profile DS1, . . . , DS4 for this replaced subcomponent S1,S2,S3,S4 (S1*,S2*,S3*,S4*) in time for the calculation in the individual function MSE and thus positively influence the health characteristic variable hx.

Furthermore, the health model 51 has an estimator ASM configured to perform a 3-stage evaluation and, in the event of the health characteristic variable hx having a value (see FIG. 2) above the first time profile 10, to assign a first state gn to a state value ZW. In the event of the health characteristic variable hx having a value below the first time profile 10 but still above a third time profile 30, a second state or is assigned to the state value ZW. In the event of the health characteristic variable hx having its value below the third time profile 30, a third state rt is assigned to the state value ZW.

In FIG. 2, the time profiles 10,20 of the health characteristic variable hx or the base characteristic variable bx are mapped over the operating time OT. The screen view DB is thus formed as divided into a region for the time profiles and into a region for menus or further display fields. A machine selector MS can be used to select a machine 1 to be considered. An output window AF shows the currently ascertained health characteristic variable hx. A switch US can be set to a prediction mode. A first selection menu M1 permits a selection of different quantities. A second selection menu M2 enables a choice as to whether or not to include a maintenance operation. A machine info field I shows relevant machine data.

Hence, the first time profile 10 displays a base characteristic variable bx over the operating time t, where the first time profile 10 of the base characteristic variable bx represents a state of the reference machine R1 at the time of consideration t in dependence on the operating time OT. The health characteristic variable hx is displayed as the second time profile 20 and is calculated from the ascertained actual characteristic variable hi plus the addition of the base characteristic variable bx. The third time profile 30 forms a lower limit and the fourth time profile 40 forms an upper limit, thus a risk corridor is spanned around the second time profile 20. For a quick and visual health estimation of the machine 1, a three-stage evaluation can be performed, for this purpose, the state value ZW is requested and, at a first state gn, the color green is displayed, at a second state or, the color orange is displayed and, at a third state rt, the color red is displayed. At a time WT, the machine 1 has probably undergone maintenance and there is a jump in the health characteristic variable hx or a jump in the second time profile to the upper limit.

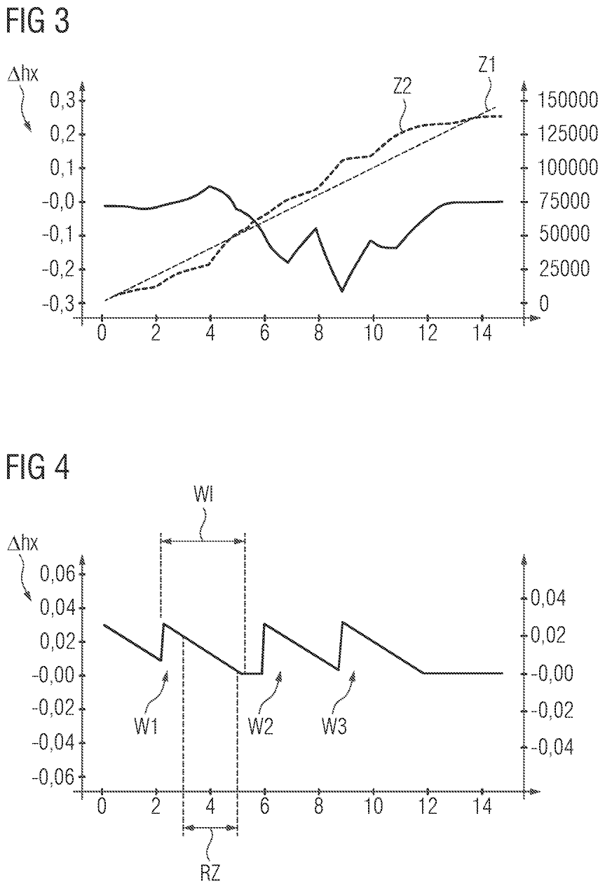

FIG. 3 visualizes the influence of the quantities Z1,Z2 of manufactured units U to be manufactured. The manufactured quantity Z1 of the reference machine R1 is a linear function. If the quantity Z2 of the machine 1 is now considered, then it is possible to conclude that, if the manufactured quantity Z2 is above the quantity Z1 of the reference machine R1, then this has a negative effect on the health characteristic variable hx and accordingly there is an effect Δhx on the health index hx.

FIG. 4 shows the effect on the health index Δhx using the example of maintenance intervals that have occurred. The performance of maintenance W1 has a positive effect Δhx on the health characteristic variable hx, but, as time progresses, this effect decreases again until a second maintenance W2 when there is again a positive effect ΔHX on the health index hx until a third maintenance W3, and so on. The individual function MSE now evaluates the period between two successive maintenance operations W1,W2 and a remaining residual time RZ to the next maintenance interval such that, as a correction factor K3, it reduces the health characteristic variable hx as time passes.

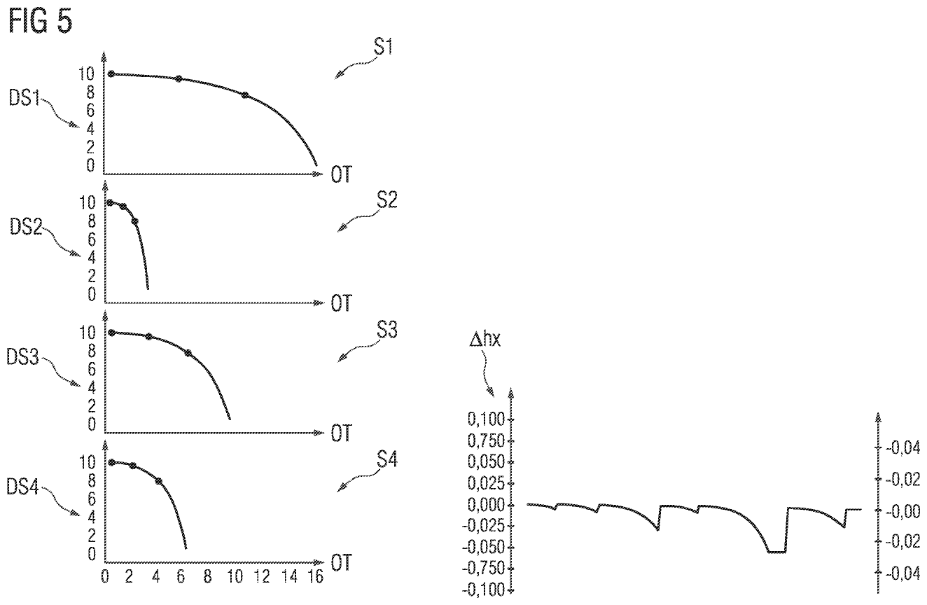

FIG. 5 depicts the degradation profiles DS1,DS2,DS3,DS4 for the subcomponents S1,S2,S3,S4 in each case. Accordingly, the machine 1 is divided into the subcomponents S1, . . . , 54 and each subcomponent S1, . . . , 54 has a specific degradation profile DS1, . . . , DS4. The individual function MSE uses the degradation profiles DS1, . . . , DS4 for the calculation of the actual characteristic variable hi. Here, the special feature is that, with regard to servicing after a subcomponent S1, . . . , 54 has been replaced by a replacement part, the associated degradation profile DS1, . . . , DS4 is shifted in time for the calculation in the individual function MSE and thus has a positive impact on the health characteristic variable hx.

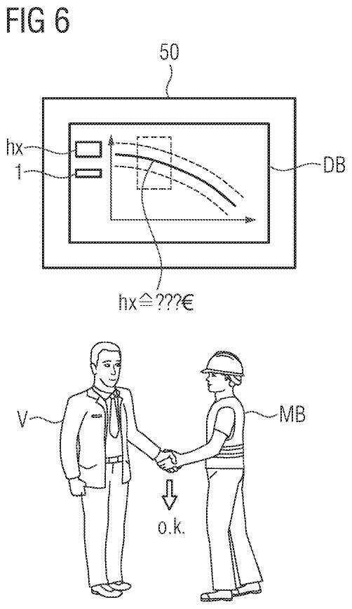

FIG. 6 shows an insurer V and a machine operator MB in contract negotiations regarding the machine 1 to be insured. The screen view DB with the time profiles and in particular the risk corridor now provides the insurer V and the machine operator MB with a good basis for mutually agreeing an insurance rate € for the machine 1 that is fair to both parties.

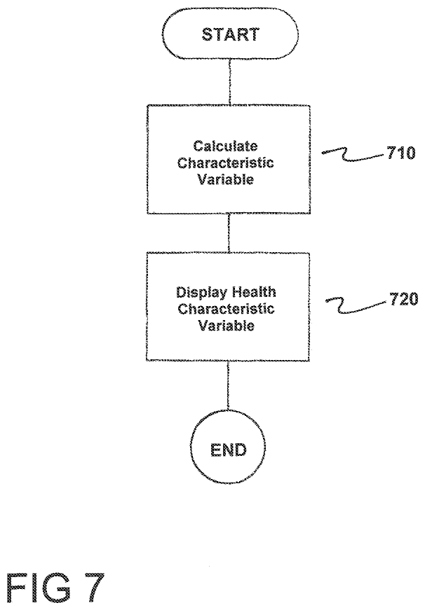

FIG. 7 is a flowchart of the method for ascertaining a health characteristic variable hx of a machine 1 at a current time of consideration t and for future times of consideration t′, where the health characteristic variable hx represents a state of the machine 1 at the current time of consideration t in dependence on an operating time OT for which purpose a base function BE is used, which maps a first time profile 10 of a base characteristic variable bx over the operating time t, the first time profile of the base characteristic variable bx represents a state of a reference machine R1 at the time of consideration t in dependence on the operating time OT and which is ascertained from either (i) historical observations of a group G consisting of a plurality of machines of the same type or (ii) knowledge-based expectations based on at least three consecutive data points P1,P2,P3, and the base characteristic variable bx represents a state of the reference machine R1 at the time of consideration t in dependence on an operating time OT.

The method comprises calculating an actual characteristic variable hi that varies over the operating time OT via an individual function MSE, as indicated in step 710. In accordance with the method, an input variable fed to the individual function (MSE) is a performance characteristic variable LK of the machine 1, which is either detected periodically via a machine data detection unit MDE or predicted for future operating times t′.

Next, the health characteristic variable hx is displayed as a second time profile 20 by adding the ascertained actual characteristic variable hi or the predicted actual characteristic variable hi to the first time profile 10, as indicated in step 720.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for ascertaining a health characteristic variable of a machine at a current time of consideration and for future times of consideration, the health characteristic variable representing a state of the machine at the current time of consideration in dependence on an operating time for which purpose a base function is used, which maps a first time profile of a base characteristic variable over the operating time, the first time profile of the base characteristic variable representing a state of a reference machine at the time of consideration in dependence on the operating time and which is ascertained from one of (i) historical observations of a group consisting of a plurality of machines of the same type or (ii) knowledge-based expectations based on at least three consecutive data points, and the base characteristic variable representing a state of the reference machine at the time of consideration in dependence on an operating time, the method comprising:
calculating an actual characteristic variable which varies over the operating time via an individual function, an input variable fed to the individual function being a performance characteristic variable of the machine, which is one of detected periodically via a machine data detection unit or predicted for future operating times; and
displaying the health characteristic variable as a second time profile by adding the ascertained actual characteristic variable or the predicted actual characteristic variable to the first time profile.

2. The method as claimed in claim 1, wherein, for the historical observations for the base characteristic variable, a quantity of manufactured units per time unit of the reference machine is defined as an observation parameter;
wherein, for the periodically detected performance characteristic variable, a quantity of manufactured units per time unit of the machine is also selected; and
wherein a deviation between the quantity of the reference machine and the quantity of the machine is provided as a factor and is utilized in the individual function as a correction factor for the calculation of the actual characteristic variable, such that a result of the health characteristic variable is optimized and the second time profile is influenced such that it is more informative.

3. The method as claimed in claim 1, wherein a further input variable fed to the individual function comprises an installation site of the machine with which environmental factors describing the environmental influences on the machine at the installation site of the machine are ascertained; and
wherein, in the individual function, at least one environmental factor is utilized as at least one further correction factor for the calculation of the actual characteristic variable which influences the health characteristic variable and thus the second time profile.

4. The method as claimed in claim 2, wherein a further input variable fed to the individual function comprises an installation site of the machine with which environmental factors describing the environmental influences on the machine at the installation site of the machine are ascertained; and
wherein, in the individual function, at least one environmental factor is utilized as at least one further correction factor for the calculation of the actual characteristic variable which influences the health characteristic variable and thus the second time profile.

5. The method as claimed in claim 1, wherein a further input variable fed to the individual function comprises a period between two successive maintenance operations forming the basic maintenance interval, and a remaining residual time to the next maintenance interval; and
wherein, in the individual function, the remaining residual time is utilized as a further correction factor for the calculation of the actual characteristic variable which influences the health characteristic variable and thus the second time profile.

6. The method as claimed in claim 1, wherein the machine is divided into subcomponents and a degradation profile is provided for each subcomponent;
wherein, in the individual function, the degradation profiles of the subcomponents are used for the calculation of the actual characteristic variable;
wherein, when a subcomponent has been replaced by a replacement part, the associated degradation profile is shifted in time for the calculation in the individual function such that the health characteristic variable is positively influenced.

7. The method as claimed in claim 1, wherein, in a screen view for a health estimation of the machine, in addition to the first time profile and the second time profile, a third time profile and a fourth time profile are displayed;
wherein the third time profile is a lower limit for a permissible range of the health characteristic variable and the fourth time profile is an upper limit for a permissible range of the health characteristic variable;
wherein a 3-stage evaluation is performed for the health estimation of the machine and, in an event of the health characteristic variable having a value above the first time profile, a first state (gn) is assigned to a state value; and
wherein in the event of the health characteristic variable having a value below the first time profile but still above the third time profile, a second state is assigned to the state value and, in the event of the health characteristic variable having a value below the third time profile, a third state is assigned to the state value.

8. The method as claimed in claim 1, wherein online calculation of machine insurance is performed to ascertain insurance rates; and
wherein the actual state and the deterioration of the machine is visually displayed to a machine operator and an insurer such that an insurance risk is determinable, the insurance rates being dynamically adjusted.

9. The method as claimed in claim 2, wherein an exponential function is utilized in the base function in accordance with the following relationship:
h(t)=1−d−exp(at^{b}), and
wherein a function with the following subfunctions is utilized in the individual function,
where the actual characteristic variable (hi)=A*K1+B*K2+C*K3+D*Σf(t), subcomponents.

10. A computer system which ascertains a health characteristic variable of a machine at a current time of consideration and for future times of consideration, the health characteristic variable representing a state of the machine at the time of consideration in dependence on an operating time, the computer system comprising:
a health model comprising:
a base estimator configured to utilized a base function to map a first time profile of a base characteristic variable over the operating time on a screen view, the first time profile of the base characteristic variable representing a state of a reference machine at the time of consideration in dependence on the operating time and being ascertained one of from (i) a database with historical observations of a group consisting of a plurality of machines of the same type or (ii) a knowledge database with knowledge-based expectations based on at least three consecutive data points, the base characteristic variable representing a state of the reference machine at the time of consideration in dependence on an operating time; and
a machine estimator, which is configured to calculate an actual characteristic variable which varies over the operating time via an individual function, an input variable fed to the individual function being a performance characteristic variable of the machine, which is periodically detected via a machine data detection unit and which is retrievable in a memory for performance characteristic variable data or is predictable for future operating times via a predictor; and
a calculation unit configured to provide a second time profile as a health characteristic variable by adding the ascertained actual characteristic variable (hi) or the predicted actual characteristic variable (hi) to the first time profile.

11. The computer system as claimed in claim 10, wherein the database for the historical observations for the base characteristic variable contains a quantity of manufactured units per time unit of the reference machine as an observation parameter;
wherein the performance characteristic variable data for the periodically detected performance characteristic variable furthermore likewise contains a quantity of manufactured units per time unit of the machine; and
wherein the individual function is configured to utilized a deviation between the quantity of the reference machine and the quantity of the machine as a correction factor in the calculation of the actual characteristic variable, such that a result of the health characteristic variable is optimized and the second time profile is influenced in such that it is more informative.

12. The computer system as claimed in claim 10, wherein the machine data detection unit contains infrastructure data and the individual function is configured to evaluate, as a further input variable, an installation site of the machine and is furthermore configured to ascertain therefrom environmental factors describing the environmental influences on the machine at the installation site of the machine; and
wherein the individual function is configured to utilize at least one environmental factor as at least one further correction factor for the calculation of the actual characteristic variable.

13. The computer system as claimed in claim 11, wherein the machine data detection unit contains infrastructure data and the individual function is configured to evaluate, as a further input variable, an installation site of the machine and is furthermore configured to ascertain therefrom environmental factors describing the environmental influences on the machine at the installation site of the machine; and
wherein the individual function is configured to utilize at least one environmental factor as at least one further correction factor for the calculation of the actual characteristic variable.

14. The computer system as claimed in claim 10, wherein the individual function is configured to evaluate a period between two successive maintenance operations forming the basic maintenance interval, and a remaining residual time to the next maintenance interval as a further input variable; and
wherein the individual function is configured to utilize the remaining residual time as a further correction factor for the calculation of the actual characteristic variable.

15. The computer system as claimed in claim 9, wherein the individual function is configured to evaluate a period between two successive maintenance operations forming the basic maintenance interval, and a remaining residual time to the next maintenance interval as a further input variable; and
wherein the individual function is configured to utilize the remaining residual time as a further correction factor for the calculation of the actual characteristic variable.

16. The computer system as claimed in claim 12, wherein the individual function is configured to evaluate a period between two successive maintenance operations forming the basic maintenance interval, and a remaining residual time to the next maintenance interval as a further input variable; and
wherein the individual function is configured to utilize the remaining residual time as a further correction factor for the calculation of the actual characteristic variable.

17. The computer system as claimed in claim 10, wherein the individual function is configured to evaluate degradation profiles of subcomponents of the machine, a subcomponent library being provided for this purpose;
wherein the degradation profiles are allocated to subcomponents of the machine;
wherein the individual function is configured to utilize the degradation profiles of the subcomponents for the calculation of the actual characteristic variable and, as time progresses, to reduce the actual characteristic variable; and
wherein the health model is configured, when a subcomponent has been replaced by a replacement part, to shift the associated degradation profile for this replaced subcomponent in time for the calculation in the individual function and thus positively influence the health characteristic variable.

18. The computer system as claimed in claim 10, wherein the computer system is configured, in addition to the first time profile and the second time profile, to display a third time profile and a fourth time profile in the screen view for the health estimation of the machine;
wherein the third time profile is formed as a lower limit for a permissible range of the health characteristic variable and the fourth time profile is formed as an upper limit for a permissible range of the health characteristic variable;
wherein an estimator configured to perform a 3-stage evaluation is provided for the health estimation of the machine;
wherein in an event of the health characteristic variable having a value above the first time profile, a first state is assigned to a state value;
wherein in an event of the health characteristic variable having a value below the first time profile but still above the third time profile, a second state is assigned to the state value; and
wherein in an event of the health characteristic variable having a value below the third time profile, a third state is assigned to the state value.

19. The computer system as claimed in claim 10, wherein the computer system performs an online calculation of a machine insurance and ascertains insurance rates; wherein the actual state and deterioration of the machine is visually displayable to the machine operator and an insurer on the screen view such that an insurance risk is bilaterally determinable, insurance rates being dynamically adjustable.
